(19) United States
(12) Patent Application Publication
(10) Pub. No.: US 2006/0204633 A1
(43) Pub. Date: Sep. 14, 2006

(54) TeaCafe'

(76) Inventor: J. David Moore, Bloomington, IL (US)

Correspondence Address: J. DAVID MOORE, P.O. BOX 992, NORMAL, IL, 61761, US

(21) Appl. No.: 11/367,441

(22) Filed: Mar. 3, 2006

Related U.S. Application Data
(60) Provisional application No. 60/659,206, filed on Mar. 7, 2005.

(51) Int. Cl. A23L 2/00

(52) U.S. Cl. 426/590

(57) ABSTRACT

A mixture or blend of Coffee and Tea into a new beverage comprised of blended quantities of dry ground Coffees and Teas into a single product. Herbal teas may also be added to blends to deliver flavor, health benefits, and in some mixtures help blend the Coffees and Teas. When the mixture is brewed or infused with hot water, the acids and oils extracted interact in a new way. The Coffee acids and oils in fluid, enter the Tea and any Herbal materials, and changes the extraction at that point. The Tea acids and oils in fluid enter the Coffee and any herbal materials, and the Coffee extraction is changed at that point. As all the extracted fluids mix and interact, a third change, a blending, and TeaCafe' is created. This process may take place in a teabag or pod, cup or container, or in a coffee or tea brewing machine material chamber and receptacle, hot water pot, or teapot.

### FIELD OF THE INVENTION

This invention is a new mixture or blend of traditional beverage components. The invention TeaCafe', is a blend of coffee and tea into a new synergistic compound. This application claims the benefit of provisional patent application Ser. No. 60/659,206, filed Mar. 7, 2005.

### BACKGROUND OF THE INVENTION

The beverages known by the popular names Coffee and Tea, are well known from their usage in the daily lives of most Americans. The inventor has found no prior mixtures of these two products into a single beverage component.

Coffee, the beverage made from the processed bean of the coffea arabica plant, is used as a morning wake up, and as a stimulating refreshment throughout the day. Due to it's popularity, decaffeinated coffee blends allow coffee drinkers to enjoy the flavor without the stimulation provided by the caffeine.

The advantage of coffee as a beverage is it's quick metabolic stimulation of the nervous system, resulting in a temporary increase of energy and vigor. This quick wake up feature is one of the primary appeals that have made it a staple of our modern culture. The disadvantage of coffee is the acid it produces in the stomach and the related indigestion and discomfort. Too much caffeine, causing the nervous “jitters”, is another undesirable effect of the coffee. This inventor is one of the consumers who are unable to consume coffee due to these effects. This inability to drink coffee, led the inventor to conceive of this invention.

Tea, the beverage created by brewing the processed leaves of the camellia senesis plant, is a lighter drink than coffee, and is used for both stimulation and relaxation. The stimulation provided by tea is slower to take effect, longer lasting, and is generally more gentle on the digestive and nervous system than coffee. The active component in tea is gentle enough that it may in fact relax, rather than stimulate some consumers. It has also become accepted that the antioxidant properties gained by consuming tea may be beneficial to individual health. Many consumers who are health conscious, and would prefer tea on that basis, still consume coffee instead, for the increased stimulation it provides.

Herbal Teas, including traditional, cultural mixtures, and new health related teas, may be used in the invention. For the purposes of this patent, herbal teas may be defined as any leaf, bark, berry, seed, fruit, flower, stem, or root of a plant that may be prepared and brewed to make a beverage. Herbal teas are often unpalatable to most consumers, and the benefits they claim may or may not be valid. In the current market, they are mixed with either coffee or tea in order to deliver a palatable product. The inventor was unable to find any blends, or evidence of prior products that blend both coffee and tea, with an herbal tea component.

### SUMMARY OF THE INVENTION

The inventor conceived of this invention in 1974, and began the work on the invention, culminating in this document in 2003. This invention while simple as a base concept in words, was quite difficult to make into a workable product mixture. It took over 1 full year of mixing and sampling to develop the first blend into a product that was good enough to consider testing on consumers. The inventor believes that the absence of prior art relative to this invention, is directly related to the unpleasant flavor he experienced in most of the blends tested in this process.

The inventor's objectives for the invention, were [a] to provide a more gentle, stomach friendly delivery mechanism for coffee, by blending it with tea, [b] to provide an improved stimulant beverage that would deliver the initial boost of coffee, but would last longer while not causing anxiety, nervousness, or nausea, [c] to provide a stimulating beverage that would help increase workers efficiency by maintaining the stimulation effect for half a shift without a lag or let down period before lunch or the end of the work day, and [d] to provide a product that will allow increased consumption of caffeine, while reducing the side effects of indigestion and or nervousness.

### DETAILED DESCRIPTION OF THE INVENTION

The invention is a mixture or blend of the beverage components Coffee and Tea, into a synergistic compound, which when brewed, creates a new stimulant beverage. When the mixture is brewed or infused with hot water, the acids and oils extracted interact in a new way. The coffee acids and oils in the fluid, enter the tea and any herbal materials, and changes the extraction at that point. The tea acids and oils in the fluid enter the coffee and any herbal materials, and the coffee extraction is changed at that point. As all the extracted fluids mix and interact, a third change, a blending, and TeaCafe' is created. This process may take place in a teabag or pod, cup or container, or in a coffee or tea brewing machine material chamber and receptacle, hot water pot, or teapot.

The preferred embodiment of the invention is a specific mixture of coffee [caffea arabica, or any other coffee], tea [camellia senesis, or any other tea], and yerba mate [ilex paraguaiensis] an herbal tea, into a blend used to make a refreshing stimulant beverage. The beverage may be prepared in any traditional method of preparing coffee or tea, and is detailed more specifically in the following “process” section of this document. After the blend is prepared hot, it may be served that way, or chilled and served, or poured directly over ice and served fresh. The beverage may be consumed with or without sweeteners, milk, and or creamers as desired.

An alternative embodiment of the invention is the basic mixture of coffees [caffea arabica, or any other coffees], and teas [camellia senesis, or any other teas], into a blend used to make a stimulant beverage. The dry mixture may be prepared in any of the methods detailed in the “process” section of this document. The resulting beverage may be served in the same manner described in the preferred embodiment of the invention.

An alternative embodiment of the invention is a mixture of dry coffee [caffea arabica, or any other coffee], teas [camellia senesis, or any other teas], and one or more type of herbal tea material, which can be used to brew a stimulating beverage. The dry mixture may be prepared in any of the methods detailed in the process section of this document. The resulting beverage may be served in the same manner described in the preferred embodiment of the invention.

An alternative embodiment of the invention is a mixture of powdered dry instant coffee, with powdered dry instant tea, and any instant herbal material desired. This mixture can be made into a stimulating beverage by adding hot or cold water and stirring until mixed. This beverage may be served in the same manner described in the preferred embodiment of the invention.

An alternative embodiment of the invention is a mixture of the fluid beverages coffee and tea, and may or may not include herbal tea fluids if desired. Quantities of the individual beverages may be mixed after brewing to make a beverage blend which will include some of the benefits of the preferred embodiment mixture. This beverage may be served in the same manner described in the preferred embodiment of the invention.

Process

The process of the invention is comprised of three steps, mixture of the dry components, brewing or infusing the beverage from the dry mixture, and preparing the beverage to serve.

Mixing the dry coffee, tea, and any herbal components may be accomplished by shaking or stirring. Combine the specific proportions for the blend desired into a dish, bowl, canister, or mixing jar and shake or stir vigorously, until the components are visibly integrated and no longer appear as separate materials. The mixture may be used immediately or stored for future use.

Brewing or infusing the mixture into a beverage may be accomplished in any known method of making coffee and or tea, and is not limited to the methods herein described.

An automated or manual brewing machine for tea or coffee may be used to make the invention blend into a beverage. Fill the brewing materials chamber or filter with the dry mixture, following the manufacturers brewing instructions, add the proper amount of water and brew.

The mixture may also be infused or brewed in a teabag, pod, or any other cooking materials bag. Fill with desired quantity of the invention mixture, and place bag or pod in cup, pan, teapot, or other water heating device, add hot to boiling water and allow to brew for 2-5 minutes to taste. Strain or drain the mixture bag or pod, and discard contents. The remaining beverage is ready to consume or store as needed.

The mixture may be brewed as a loose material in a cup, pan, hot water pot, or teapot. Fill receptacle with desired quantity of water and heat to the point of boiling, then remove from the heat source or unplug. Carefully add the dry mixture to the hot water and stir until all materials are wet. Brew for 2-5 minutes to taste, then separate the solids by pouring the mixture through a strainer or filter. Discard the solids and serve the resulting beverage fresh or store for later use.

Serving the prepared beverage, may be accomplished in any traditional method deemed effective to the consumer, and is not limited to the following methods. Hot TeaCafe' may be served with or without sweetener, milk, and or creamers. The chilled beverage, Iced TeaCafe', may be served freshly brewed, poured over ice, then sweetened to taste or left unsweetened, milk or creamer may also be added if desired. The beverage may also be chilled prior to serving and be served with or without ice. The beverage may also be frozen and served as a cool refreshment.

It is to be understood that the invention is not limited to the particular embodiments described herein, and that it can be carried out in various ways.

1. A beverage mixture, comprising; a blended quantity of dry coffees [caffea arabica, or any other coffee], and teas [camellia senesis, or any other tea], into a single product blend, said blended product may be brewed or infused with hot to boiling water, resulting in a new stimulant beverage, said beverage may be served hot, with or without sweetener, milk and or creamer, said beverage may be served chilled or poured over ice to chill freshly brewed, and may be served with or without sweetener, milk, and or creamer, said beverage may be prepared to taste and frozen to be served as a cold refreshment, said beverage may also be processed after brewing to be used as a flavoring or ingredient in candy, confections, and or baking.

2. A beverage mixture, comprising; a blended quantity of dry coffees [caffea arabica, or any other coffee], teas [camellia senesis, or any other teas], and yerba mate [ilex paraguariensis] into a single product blend, said blended product may be brewed or infused with hot to boiling water, resulting in a new stimulant beverage, said beverage may be used in any of the manners herein described in claim 1.

3. A beverage mixture, comprising; a blended quantity of dry coffees [caffea arabica, or any other coffees], teas [camellia senesis, or any other teas], and any herbal teas into a single product blend, said blended product may be brewed or infused with hot to boiling water resulting in a new stimulating beverage, said herbal teas to be defined as any leaf, bark, berry, seed, flower, stem, or root of a plant that may be prepared and brewed to make a beverage, said beverage may be used in any of the manners herein described in claim 1.

4. A beverage mixture, comprising; a mixture of dry instant coffee, with dry instant tea into a single product blend, said blended product may be mixed or infused with hot to boiling water, resulting in a new beverage, said blend may or may not include any instant herbal teas, herbal teas defined as herein described in claim 3, said beverage may be used in any of the manners herein described in claim 1.

5. A beverage mixture, comprising; a mixture of the fluid beverages coffee [caffea arabica, or any other coffee], and tea [camellia senesis, or any other teas] into a single product, said blend may or may not include herbal tea fluids, defining herbal teas as described herein in claim 3, said beverage may be used in any of the manners herein described in claim 1.

6. A beverage mixture, comprising; any of the products in claims 1,2,3,4, and 5, where some or all of the contents are decaffeinated, said beverage may be used in any of the manners herein described in claim 1.
